(19) United States
(12) Patent Application Publication
(10) Pub. No.: US 2003/0009705 A1
(43) Pub. Date: Jan. 9, 2003

(54) Monitoring and synchronization of power use of computers in a network

(76) Inventors: Michael Thelander, Gresham, OR (US); Peter Carbon, Beaverton, OR (US); Cindy Tatham, North Plains, OR (US)

Correspondence Address: BANNER & WITCOFF, LTD., 1001 G STREET, N.W., WASHINGTON, DC, 20001-4597, US

(21) Appl. No.: 10/081,728

(22) Filed: Feb. 21, 2002

Related U.S. Application Data
(60) Provisional application No. 60/304,136, filed on Jul. 9, 2001.

(51) Int. Cl. G06F 1/26

(52) U.S. Cl. 713/340

(57) ABSTRACT

A method and system for controlling the power management profiles of computers connected through a network. The method and system monitoring the electrical power use of each computer in the network, and reports this information to an authorized party, such as the network administrator. According to the method and system, an authorized party may configure and maintain a power management profile for each computer in the network. In particular, the authorized party may individually configure and maintain a power management profile for each computer. Alternately, each computer in the network can be classified in a group, and the authorized manager can then configure and maintain a single power management profile shared by each computer in the group.

### RELATED APPLICATION INFORMATION

This application is a continuation-in-part application of U.S. Provisional Patent Application No. 60/304,136, filed on Jul. 9, 2001, which application is incorporated entirely herein by reference.

### FIELD OF THE INVENTION

The present invention relates to a method and system for monitoring and controlling the use of electrical power by computers. More particularly, the present invention relates to a method and system for monitoring and recording information relating to the electrical power usage by computers. The invention also relates to scheduling the use of power settings and power states by computers. Still further, the invention allows both the scheduling of power setting and power states and instructions to monitor and record power usage information to be distributed and synchronized among a plurality of computers in a network.

### BACKGROUND OF THE INVENTION

Many people erroneously believe that heavy industries, from silicon chip manufacturing to aluminum and steel manufacturing, represent the largest drain on power resources in the United States. A 1999 report by the Lawrence Berkeley National Labs, however, indicated that among the industrial, commercial, residential, and network sectors, the commercial sector (e.g., insurance, banking, finance, retail, etc.) was responsible for over 70% of all power consumption in the United States. Further, some studies have indicated that annual energy usage by office and network equipment of all types represents about 2% of U.S. total energy usage. Exacerbating this unexpectedly high consumption rate is the fact that many of the computers and monitors drawing this power are doing so even when they are not in use. Systems in the commercial sector often draw the same power when they are inactive as when they are experiencing high workloads, even during nights and weekends.

In an effort to reduce computers' unnecessary power consumption, the Advanced Power Management (APM) standard was introduced in 1992 to comply with the Energy Star energy-efficiency guidelines published by the Environmental Protection Agency. This standard, which is well known in the art and which is incorporated entirely herein by reference, defines various power states into which computers and monitors can be placed when not being actively used. In addition to the on power state (where each unit of a computer is fully powered) and the off power state, this standard defines a reduced power state. As is known in the art, a reduced power state is one in which power to the computer is reduced or shut off, but the computer's context is preserved.

Another energy-saving standard developed by various members of the computer industry, the Advanced Configuration Power Interface (ACPI), is also well known in the art and incorporated entirely herein by reference. The ACPI standard defines additional reduced power states and provides more flexibility and greater robustness than the APM standard. As is commonly known to computer users, the ACPI standard provides for a standby state in which a computer's basic hardware maintains its context, but in which the computer's associated monitors and disk drives are powered off. This standard also has a suspend state, where the computer's context is saved to random access memory (RAM) for a fast wakeup, and a hibernate state where the computer's context is saved to, for example, a hard disk drive, and all units in the computer are powered off.

While the use of these standards offer the opportunity for enormous energy savings over time, these standards suffer a significant drawback in that they must actually be employed by the computer in order to be effective. Typical computer users either choose not to configure the power management settings of their computers to employ these standards, or are unaware of how to modify the power management settings of their computers to employ these standards. Thus, these energy-saving standards are not being used to their full potential.

### BRIEF SUMMARY OF THE INVENTION

Advantageously, the invention offers a method and system for defining a schedule for implementing desired power settings or power states on a computer, and for enforcing the desired power settings or power states according to the schedule. More particularly, the invention allows an authorized party to create a power management profile that includes one or more power settings or a power state, and a schedule for implementing the settings or the power state on a computer. The profile may be created locally on the computer that will employ the power management profile. Alternately, the profile may be created at a remote source and distributed to the computer through, for example, a network. When the power management profile is distributed from a remote source, it may be conveniently distributed at one time to one or more computers categorized into a single group.

The invention also provides a method and system for monitoring and recording information relating to a computer's power usage. The power usage information may include, for example, the time when a computer enters into a new power state, or the duration that the computer is in a particular power state. The power usage information may also include the power settings and power states provided by the computer's operating system. Further, the power usage information may include data relating to the makeup of the computer and power consumption information for particular components of the computer. For example, the power usage information may identify the type of processor in the computer, the type and version of the BIOS being used by the computer, or the type of monitor or other peripheral connected to the computer. The power usage information may also include data relating to how the various components of the computer or their power usage change over time.

With the invention, the instructions to monitor and record the power usage information can be generated at the local computer for which the power usage information will be monitored. Alternately, the instructions to monitor and record the power usage information can be generated at a remote source and distributed to the computer through, for example, a network. When the instructions to monitor and record the power usage information are distributed from a remote source, they may also include instructions to transmit the monitored power usage information back to the source. Also, when the instructions are distributed from a remote source, they may be conveniently distributed at one time to one or more computers categorized into a single group.

### BRIEF DESCRIPTION OF THE DRAWINGS

FIG. 1 illustrates a conventional computer operating in a network of computers.

FIG. 2 illustrates an exemplary computer network employing a server unit and client units according to an embodiment of the invention.

FIG. 3 illustrates a schematic layout of a server unit and an associated client unit according to an embodiment of the invention.

FIGS. 4 and 5 illustrate a power management user interface provided by one embodiment of the invention

FIG. 6 illustrates an interface according to an embodiment of the invention where a shutdown schedule is being used in lieu of a nighttime power setting schedule.

FIG. 7 illustrates an override interface according to an embodiment of the invention.

FIGS. 8 and 13 illustrate an interface provided to classify computers on the network employing the client unit into groups according to an embodiment of the invention.

FIGS. 9-12 illustrate an interface for defining power management profiles to be enforced by client units on client computers according to an embodiment of the invention.

FIG. 14 illustrates an interface for arranging power consumption information according to an embodiment of the invention.

FIGS. 15 and 16 illustrate tables displaying power consumption information according to an embodiment of the invention.

FIG. 17 illustrates the operation of one embodiment of the invention in defining, distributing and enforcing a power management profile.

FIG. 18 illustrates the operation of one embodiment of the invention in defining, distributing and implementing instructions to monitor and record power usage information.

### DETAILED DESCRIPTION OF THE INVENTION

Overview

The embodiments of the invention described below include two components. The first component operates as a client of the second component, and thus will sometimes be referred to hereafter as the “client unit.” This client unit monitors and records power usage information for the computer on which it is implemented, and then reports the recorded power usage information to the second unit. The client unit also interfaces with the operating system of the computer on which the client unit is implemented, in order to schedule and enforce power management settings and power states employed by the computer.

The second component serves one or more client units, and thus will sometimes be referred to hereafter as the “server unit.” This server unit provides a power usage reporting function, which collects the power usage information monitored and recorded by each client unit, so that this information may be compiled into a report. The server unit also provides a power management profile configuration function, which can be used to define a power management profile for controlling the power consumption of a computer, and then to distribute the power management profile to client units for enforcement on their associated computers.

As will be discussed in detail below, a power management profile may include one or more groups of power settings for managing power consumption on a computer, and a schedule for implementing each of those groups of power settings on the computer. A power management profile may also include one or more power states to be implemented by the computer, and a schedule for implementing each of those power states. Still further, a power management profile may include a combination of one or more groups of power settings and one or more power states, together with a schedule for implementing at least one group of power settings or power state.

Thus, the server unit allows an authorized party, such as a network administrator, to obtain power usage information for each computer in a network employing a client unit. With some embodiments of the invention, the authorized manager can use the server unit to segregate the computers of a network into different groups, and then create and assign a different power management profile to an entire group of computers rather than to individual computers. Other embodiments of the invention may allow the authorized manager to alternately or additionally configure and assign a desired power management profile to individual computers in the network with a client unit.

Conventional Programmable Computer and Computer Network

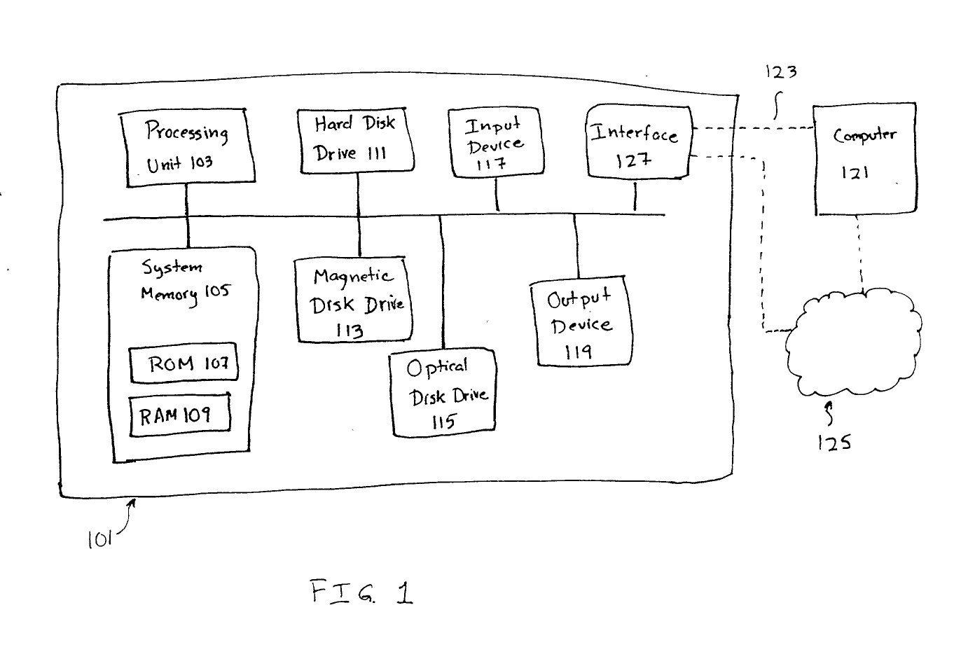

Before discussing the features and aspects of the invention in detail, it may first be useful to describe the various units of a typical computer for which the invention may be used. FIG. 1 illustrates an example of a programmable computer 101 that can communicate with other computers through a computer network, such as a commercial computer network for banking, insurance record keeping, or other business application. The computer 101 includes basic hardware, such as a processing unit 103 and a system memory 105. As will be appreciated by those of ordinary skill in the art, the processing unit 103 may be a programmable microprocessor or other programmable processing unit. The system memory 105 will typically include solid-state memory units, such as a read-only memory (ROM) 107 and a random access memory (RAM) 109. As will be appreciated by those of ordinary skill in the art, each of these basic hardware units requires some minimum amount of electrical power to operate.

The computer 101 also includes a number of peripheral units used to input information into, receive information from, and store information for the computer 101. These peripheral units may be internal or external to the body of the computer 101, and will typically consume more electrical power than the basic hardware units of the computer 101. For example, the computer 101 may include large capacity memory units, such as a hard disk drive 111 for reading from and writing to a hard disk (not shown), a magnetic disk drive 113 for reading from or writing to a removable magnetic disk (not shown), or an optical disk drive 115 for reading from or writing to a removable optical disk (not shown) such as a CD-ROM or other optical media. These peripheral units will also typically have one or more input devices 117 and one or more output devices 119. The input devices 115 may include, e.g., a keyboard, a pointing unit, a touch screen, a microphone, a joystick or any other suitable interface device. Similarly, the output devices 117 may include, e.g., a display monitor, speakers or a printer.

As previously noted, the computer 101 is capable of operating in a networked environment through connections to one or more different computers, such as the computer 121. The computer 101 may be connected to the computer 121 through a local area network (LAN) 123, or through a wide area network (WAN) 125, such as the Internet. As is known in the art, the computer system 101 is connected to a network through an interface 127, such as a wireless transceiver, a modem, an Ethernet connection, or any other suitable interface. While the interface 127 is illustrated as an internal interface in FIG. 1, it may alternately be an external interface as is well known in the art. Of course, it will be appreciated that the network connections shown in this figure are exemplary, and other means of establishing a communications link with other computers to join into a network of computers may be used.

As known to those of ordinary skill in the art, an operating system program, which may be stored in a combination of the random access memory 109 and the hard disk drive 111, controls the operation of the various components of the computer 101. Conventionally, the operating system program will include a power management function that controls the power consumption of one or more of these components. For example, the Microsoft Windows 2000 operating system includes various application programming interfaces (APIs) for controlling, among other components of the computer 101, the on/off status of a monitor used by the computer 101, the on/off status of the disk drive 111, the power consumption of the processing unit 103, and the transfer of context information for the computer 101 from the random access memory 109 to a hard disk in the disk drive 111.

These API's cooperate to provide the user with a “Power Options Properties” interface that allows a user to designate various power settings for controlling the power consumption-related characteristics of the computer. For example, the power settings will typically include a time period of inactivity after which the computer will enter a reduced power state, such as the standby or hibernate state, and a time period of inactivity after which the computer enters the off power state. Of course, other operating system programs may provide for alternate or additional power settings to control the power consumption of any computer component operated through the processing unit 103.

Further, some operating systems, such as the Windows 2000 operating system, will conveniently allow a user to collect various power settings into a single group, so that the entire group can easily be selected for implementation. These groups of power settings are sometimes referred to as “schemes.”

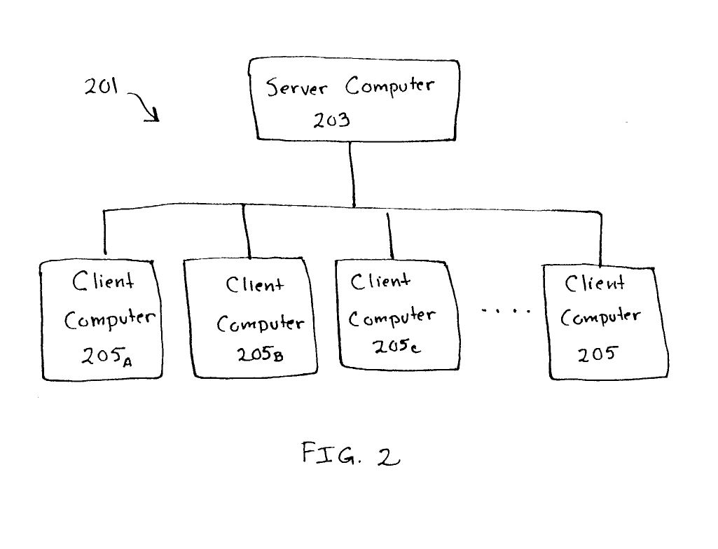

A network 201 employing one embodiment of the invention is illustrated in FIG. 2. As seen in this figure, the network 201 includes a server computer 203 and a plurality of connected client computers 205A-205φ, each of which may be a computer such as the computer 101 described above. As will be appreciated from the foregoing discussion, the server unit of the described embodiments of the invention is implemented on the server computer 203, while the client unit of the described embodiments of the invention is implemented on each client computer 205. Both the server computer 203 and the client computers 205 will be discussed in detail below.

The Client Unit

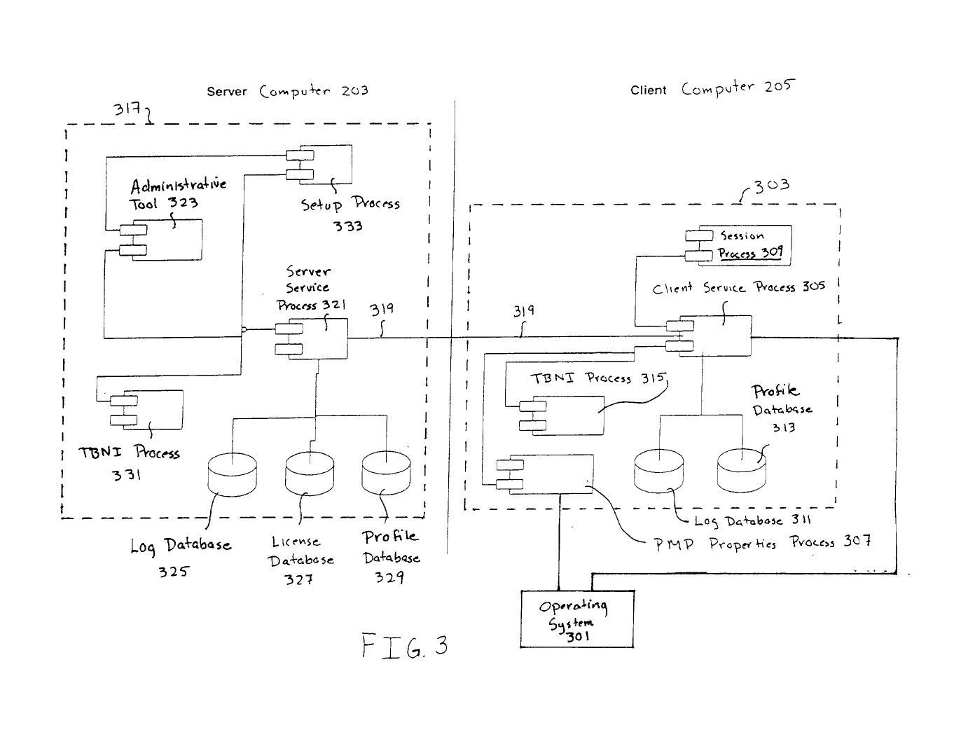

As shown in FIG. 3, a client computer 205 includes an operating system 301 and a client unit 303. As is known in the art, the operating system 301 controls the power consumption of the computer 205 according to power management settings. These power management settings determine when the computer 205 enters various power states. For example, in the illustrated embodiment of the invention, the computer 205 employs one or more power schemes. As previously noted, a power scheme is a group of one or more power management settings collectively identified and implemented using a single group name. These power schemes will place the computer 205 in any of the standby, hibernate or suspend power states defined by the Advanced Configuration Power Interface (ACPI) power management standard after a period of inactivity designated by the settings in the scheme. The power management settings thus determine when the computer 205 enters the standby state, when the computer 205 enters the hibernate state, and when the computer 205 enters the suspend state.

As seen in FIG. 3, the client unit 303 includes a client service process 305, a power management profile (PMP) properties process 307, and a session process 309. The client unit 303 also includes a client log database 311 and a client profile database 313, each of which will also be discussed in detail below. Further, the client unit 303 may optionally include a task bar notification icon (TBNI) process 315. As will be appreciated by those of ordinary skill in the art, the client service process 305, the power management profile properties process 307, the session process 309 and the task bar notification icon process 315 may each be implemented using software instructions operating on the client computer 205. As will be appreciated by those of ordinary skill in the art, such software instructions may be stored on any suitable medium, such as a magnetic disk within the hard disk drive 111. Alternately, one or more of these processes could be implemented using firmware or hardware circuitry. Both the client log data database 311 and the client profile database 313 may be embodied in any suitable memory medium, such as the RAM memory 109, the hard disk drive 111, the removable disk drive 113, or the optical disk drive 115.

Turning first to the client service process 305, this process acts as an interface between the server unit 317 implemented on the server computer 203 (discussed in detail below), the other components of the client unit 303, and the operating system 301. For example, as seen in FIG. 3, the client service process 305 provides a communication link 319 with the server unit 317. Through this communication link 319, the client service process 305 receives power management profiles from the server unit 317, and stores these profiles in a profile file maintained in the profile database 313. The client service process 305 then interfaces with the operating system 301, to enforce the power management profiles received from the server unit 317, as will be discussed in detail below. The client service process 305 also relays portions of the stored power management profiles to the power management profile properties process 307 for display to a user, and receives user input from the power management profile properties process 307 as will also be discussed in detail below.

The client service process 305 also monitors power usage information for the client computer 205, and stores the power usage information in a power usage log maintained in the log database 311. At the instruction of the server unit 317, the client service process 305 will then retrieve the power usage information from the log database 311, and provide the information to the server unit 317. Further, as will also be discussed in detail below, the client service process 305 receives exception data from the power management profile properties process 307 or other sources. The client service process 305 then stores the exception data in an exception log maintained in the log database 311 for subsequent retrieval by the server unit 317.

As previously noted, the client service process 305 interfaces with the operating system program 301 to enforce the power management profiles received from the server unit 317. More particularly, the client service process 305 receives a power management profile from the server unit 317, which includes one or more power settings or power states, and at least one schedule for implementing a power setting or power state. The client service process 305 then ensures that the power setting or the power state for the operating system 301 are set to correspond with the scheduled power setting or power state specified in the power management profile at the beginning of the time period specified in the schedule. With some embodiments of the invention, the power management profile control unit 307 may even mandate that the operating system 301 employ the settings or power state specified in the power management profile for the entire duration of the period or periods specified in the schedule.

It should be noted that a power management profile may include a schedule of any desired type. For example, the schedule may require the client unit 303 to implement a particular power setting or scheme for a reoccurring time period, such as every day between 9:00 AM and 5:00 PM. Alternately, or additionally, the schedule may require the client unit 303 to implement a power state on a particular calendar date, such as Jan. 1, 2003. Still further, the schedule may require the client unit 303 to implement a particular power setting, scheme or state on a particular calendar date for a specified time period, such as on Feb. 20, 2002, between 10:00 AM and 4:00 PM. Still other types of schedules will be apparent to those of ordinary skill in the art.

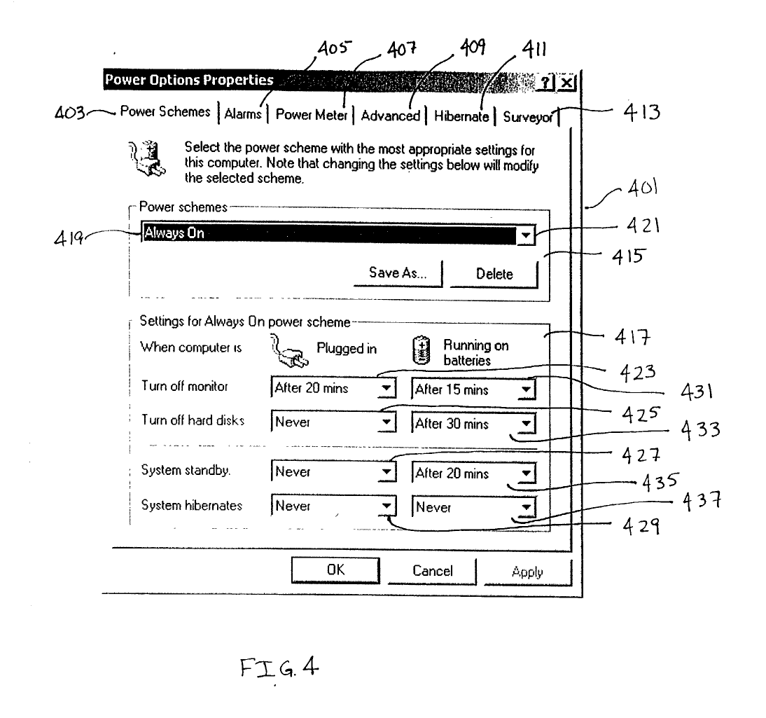

While the client service process 305 interfaces with the operating system to implement a power management profile, the power management profile properties process 307 extends the user interface provided by the operating system 301 for controlling the power management settings. For example, FIG. 4 illustrates a power management user interface provided by one embodiment of the invention, where the operating system 301 is the Microsoft Windows 2000 operating system. As seen in this figure, the interface 401 closely resembles the conventional Microsoft Windows 2000 operating system “Power Options Properties” user interface. With some embodiments of the invention, the power management profile properties process 307 may create a user interface for controlling or viewing the power management settings if the operating system 301 does not provide such an extendible user interface.

The interface 401 shown in FIG. 4, includes an interface tab 403 entitled “Power Schemes,” an interface tab 405 entitled “Alarms,” an interface tab 407 entitled “Power Meter,” an interface tab 409 entitled “Advanced,” and an interface tab 411 entitled “Hibernate.” Unlike the conventional “Power Options Properties” user interface, however, the interface 401 also includes a tab interface 413 entitled “Surveyor” provided through the operation of the power management properties process 307.

As may be seen in FIG. 4, when the interface tab 403 entitled “Power Schemes” is activated, the interface 401 includes a power schemes display 415 and a power scheme settings display 417. The power schemes display 415 includes a field 419, identifying the power scheme to be employed by the operating system 301 (in FIG. 4 named “Always On”), and a power scheme selection button 421. As is known in the art, when a user activates the power scheme selection button 421, the display 401 provides a drop down menu listing other available power schemes (if any), from which the user can select a power scheme to be employed by the operating system 301 in the future.

The power scheme settings display 417 then includes fields 423, 425, 427, 429, 431, 433, 435, and 437 displaying the power settings for the selected power scheme. In particular, the fields 423, 425, 427 and 429 display the power management settings, according to the power scheme identified in field 419, for turning off a monitor associated with the computer 101, turning off hard disk drives 111, putting the basic hardware into a standby mode, and putting the computer into the hibernate mode, respectively, when the computer is plugged into a power source. Similarly, the fields 431, 433, 435 and 437 display the power management settings, according to the power scheme identified in field 419, for turning off a monitor associated with the computer 101, turning off hard disk drives 111, putting the basic hardware into a standby mode, and putting the computer into the hibernate mode, respectively, when the computer is operating from battery power.

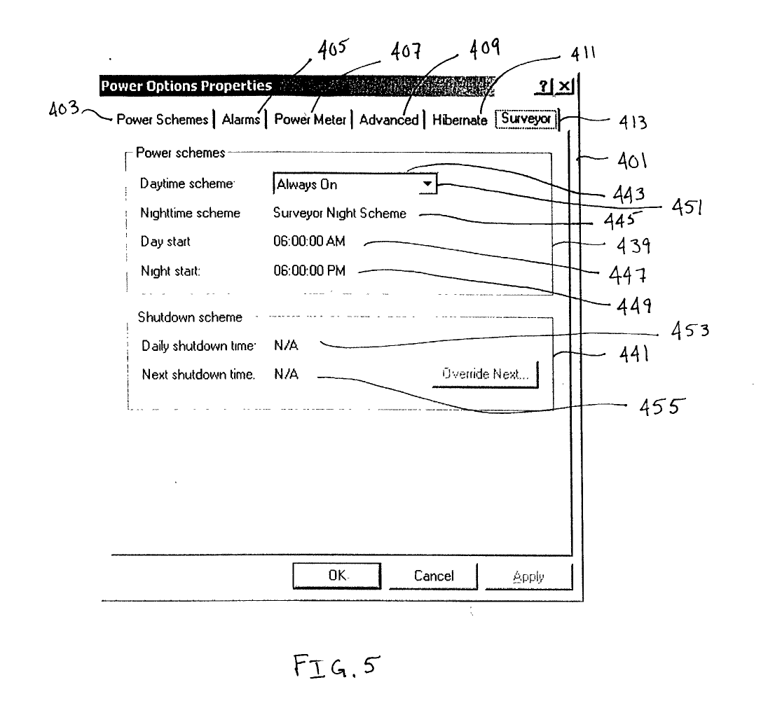

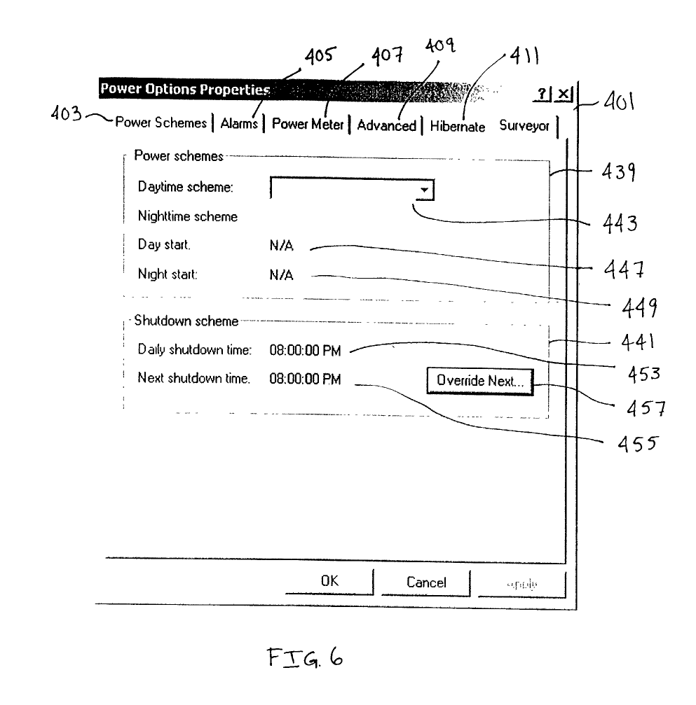

As previously noted, a power management profile may include one or more groups of power settings, together with a schedule for implementing those power settings. Thus, as shown in FIGS. 5 and 6, the interface 401 is extended to display the parameters of power management profiles that include either a scheduled power scheme (referred to as the “Nighttime scheme” in these figures), or a scheduled off power state (referred to as the “Shutdown scheme” in these figures). Accordingly, unlike a conventional Microsoft Windows 2000 operating system “Power Options Properties” interface, however, the interface 401 is extended to include the interface tab 413 (labeled “Surveyor”), which is associated with the operation of the client unit 303. When a user activates the tab 413, the interface 401 provides a power scheme display 439 and a shutdown display 441. The power scheme display 439 shows the power scheme to be implemented by the operating system 301. In the illustrated embodiment, the power scheme display 439 includes a field 443 identifying a daytime power scheme to be used by the operating system 301, and a field 445 identifying a shutdown power scheme to be used by the operating system 301. The power scheme display 439 also includes a day start field 447 and a night start field 449, indicating the schedule for implementing the daytime power scheme.

With the embodiment shown in FIG. 5, the displayed power management profile includes a scheduled power scheme instead of a scheduled off power state. The particular power scheme scheduled in the power management profile and shown in field 445 is entitled “Surveyor Night Scheme.” Field 443 of the interface 401 then displays a power scheme to be implemented outside of the scheduled time period, referred to as the “Daytime scheme.” The field 439 includes a drop-down menu button 451. When a user activates the button 451, the interface 401 provides a drop-down menu of other power schemes (if any). The user may thus select different power schemes to be implemented outside of the schedule defined in the power management profile for the nighttime power scheme. With the illustrated embodiment, the power management profile includes instructions for the client unit 303 to enforce the power management profile. Accordingly, in FIG. 5 the fields 445-449, 453 and 455 displaying the parameters of the scheduled power scheme and off power state are fixed, so that their contents cannot be modified through the interface 401. Because the power management profile for this embodiment does not happen to include a scheduled off power state, however, the daily shutdown time field 453 and the next shutdown time field 455 in the shutdown profile display 441 contain non-values (N/A).

With some embodiments of the invention, the power management profile may include multiple power settings or power schemes with the same schedule, so that the user may select between different power settings or schemes to be implemented during the scheduled time period. In these embodiments, the client unit 303 may cause the operating system to implement a default power setting or scheme for the scheduled period according to any desired criteria, such as having a preselected default setting or scheme, or using the setting or scheme most recently selected by the user. Also, with some embodiments of the invention, the power management profile may allow any user (or one or more specified users) to modify or override parameters of the profile. With these embodiments, the interface 401 may, for example, permit the user to modify the settings in fields 445 and/or 447 and 449, or provide an override button that allows the user to override implementation of the power management profile.

FIG. 6 illustrates an embodiment of the invention where the off power state (that is, the shutdown scheme) is scheduled in lieu of the nighttime power scheme. As seen in this figure, the daily shutdown time field 453 identifies the time each day (that is, 8:00 PM) at which the computer 205 is scheduled to shut down according to the power management profile provided by the server unit 317. The next shutdown time field 455 then identifies the next time (that is, 8:00 PM) that the computer 205 is scheduled to shut down according to the power management profile.

With the embodiment of the invention displayed in FIG. 6, the power management profile also includes instructions for the client unit 303 to enforce the power management profile. Accordingly, in the fields 443-449, 453 and 455, the parameters of the scheduled power scheme and scheduled off power state are fixed, so that a user cannot modify their contents through the interface 401. In this embodiment, however, the power management profile also includes instructions allowing a user to override a scheduled shutdown of the computer 203. Thus, the shutdown profile display 441 provides an “Override Next” button 457, which the user may activate to override shutdown of the computer 205 at the next scheduled shutdown time.

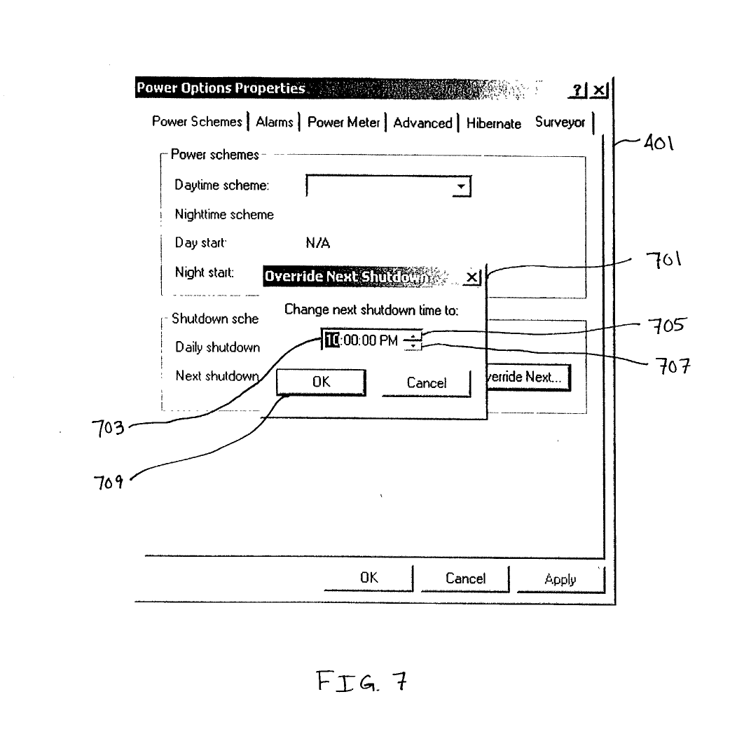

More particularly, when a user activates the button 457, the client unit 303 provides an override interface 701, shown in FIG. 7. The interface 701 includes a field 703 identifying the shutdown time for the next scheduled shutdown of the computer 205. By activating up and down buttons 705 and 707, the user may override the schedule for the next shutdown time designated in the power management profile, and instead select a new time when the computer 205 will next shut down. The user can then activate button 709 to have the client unit 303 implement this override shutdown time.

With some embodiments of the invention, the power management profile will not allow a user to override a scheduled shutdown. Thus, the computer 205 may shutdown even if the computer's user still has one or more files active. With these embodiments, the client unit 303 may be configured to backup any files that are still active immediately before a forced shutdown of the computer. The location of these backup files may then be saved, for example, in a saved file folder. Some embodiments of the invention may even provide a button in the interface 401 to easily and conveniently open the saved file folder, or other mechanism for easily accessing forcibly saved files.

From the foregoing description, it will be appreciated by those of ordinary skill in the art that the profile file in the profile database 313 can store a number of different power management profiles. Typically, only one power management profile will be implemented on a computer 203 at any time. It should be noted, however, that a single computer 205 may switch between power management profiles contained in the profile database 313 without prompting from the server unit 317. For example, if the client computer 205 is portable, the server unit 317 may provide the client unit 303 with one power management profile to be implemented when the client computer 205 accesses the network 201 from a first location, and a different power management profile to be implemented when the client computer 205 accesses the network 201 from a second location (or, alternately, any other location than the first location). Also, the server unit 317 may provide the client unit 303 with a power management profile to be implemented when a first user is using the client computer 205, and a different power management profile to be implemented when a second user (or, alternately, when anyone other than the first user) is using the client computer 205.

Referring back to FIG. 3, the session process 309 monitors the use of the computer 205, and reports to the client service process 305 when a user logs onto or logs off from the client computer 205. Thus, the client service process 305 can use the login information from the session process 309 to implement user-specific power management profiles.

Also, as previously noted, some power management profiles may allow specific individuals to modify or override their parameters. For example, a power management profile may allow an authorized party, such as a network administrator, to modify or override its parameters. Alternately, the client unit 303 itself may be configured to allow an authorized party to modify or override any power management profile. The client service process 305 can therefore use the login information from the session process 309 to determine when a user can modify or override a power management profile.

As discussed above, some power management profiles may allow a user to modify or override a scheduled switch to a power setting or power state. With various embodiments of the invention, a power management profile or the client unit 303 may also allow an application or other source to modify or override a scheduled switch to a power setting or power state. For example, the computer 205 may occasionally run a database application that requires several hours to update, during which time the computer cannot shutdown or enter a reduced power state. Thus, the database application may be allowed to override or modify an existing power management profile to complete an update without interruption.

The occurrences of such modifications or overrides of a power management profile, whether by the user, the application, or by some other entity, may be of interest to the authorized party who defined the power management profile. For example, if a user routinely overrides a scheduled shutdown, then the authorized party may want to change (or more strictly enforce) the power management profile scheduling the shutdown for that user. Accordingly, each time that a parameter of a power management profile is modified or overridden, the client unit 303 monitors the exception to the implementation of the power management profile, and records the exception information in the exception log in the log database 311. The server unit 317 can then subsequently retrieve this exception information, thereby allowing an authorized manager to determine how closely the designated shutdown profile is being followed.

Referring back now to FIG. 3, the client service process 305 also monitors and records the power usage information for the computer 205, as previously noted. As will be appreciated by those of ordinary skill in the art, the client service process 305 can monitor a variety of power usage information, including information relating to the computers' power consumption. Further, the computer's power consumption may be monitored using a wide range of techniques. For example, the client service process 305 may estimate the power consumption of the computer 205 based upon enforcement of the power management profiles implemented by the computer 205 over time. Alternately, the client service process 305 may monitor when the computer 205 switches to a new power state, the identity of that power state, and the time period the computer 205 remains in that power state before switching to another power state. With estimates of the amount of power used by the computer 205 in each power state (provided by, for example, the network administrator), this power usage information can be employed to estimate the total amount of power consumed by the computer over time.

Still further, with some embodiments of the invention, the client service process 305 may monitor specific power control commands sent from the operating system 301 to the various components of the computer 205. With this information and the estimated power consumption of each unit in the computer 205 (stored, for example, in a lookup table), the client service process 305 can calculate the amount of power being consumed by the computer 205 at any given time. Still further, with some embodiments of the invention, the client unit 303 may include a physical power measurement unit that actually measures all electrical power delivered to the computer 205, and provides this information to the client service process 305.

Moreover, in addition to the estimated or actual power consumed, the power usage information may include the power settings, power schemes or other power management controls available on the computer 203. Thus, the client service process 305 may submit inquiries to the operating system 301 regarding the various power states supported by the operating system 301. The power usage information may also include the types, configuration or power consumption of hardware or software employed by the computer, the types, configuration or power consumption of peripherals connected to the computer 205, and changes in the type, configuration, or power consumption of components of the computer 205 or peripheral equipment connected to the computer 205. For example, the usage information may include the type of processor being used by the computer and the amount of power typically used by the processor. Still other types of power usage information may be monitored, depending upon the application and operating environment of the invention.

After the client service process 305 monitors the desired power usage information, it stores the power usage information in the power usage log maintained in the log database 311. The client service process 305 can then retrieve the usage data from the power usage log and provide the data to the client server unit 317 at a later time. As will be appreciated by those of ordinary skill in the art, the client service process 305 may retrieve and forward the data to the server unit 317 periodically, upon request by the server unit 317, or both.

With the embodiments of the invention described above, the client unit 303 may be implemented by software instructions operating on the client computer 205. As will be appreciated by those of ordinary skill in the art, such software instructions may be maintained on any suitable medium, such as a magnetic disk within the hard disk drive 111. It should be noted, however, that with alternate embodiments of the invention the client unit 303 might be a discrete device separate from the client computer 205. For example, the client unit 303 may be a standalone device employing software, hardware, firmware, or any combination thereof. With these embodiments, the client unit 203 may communicate with the computer 205 so as to control implementation of the power management profiles and monitor the desired power usage information.

Also, while the client unit 303 for the above-described embodiments are connected to and receive power management profiles from a server unit 317, it should be noted that the client unit 303 might alternately be implemented as a local application on a standalone computer 101. With these embodiments, the user of the computer 101 can define power management profiles on the computer 101, rather than receiving the power management profiles from a server unit 317. The user may also determine the degree to which each power management profile is enforced, and monitor and record desired power usage information.

The Server Unit

As previously noted, the network 201 shown in FIG. 2 includes at least one server computer 203, which may also be a computer such as the computer 101 described above. Referring back now to FIG. 3, the server unit 317 is implemented on the computer 203. The server unit 317 includes a server service process 321, and an administrative tool 323. As will be discussed in detail below, the server service process 321 acts as an interface between the client unit 303 and the other components of the server unit 317. As will also be explained in detail below, the administrative tool 323 allows an authorized party (such as a network administrator) to gather and view the power usage information collected by the client units 303 on each client computer 205. The administrative tool 323 also allows an authorized party to define power management profiles for each client computer 205.

The server service process 321 then communicates with the client unit 303 in each client computer 205, to retrieve power usage data to the administrative tool 323 and distribute the power management profiles parameters from the administrative tool 323.

The server unit 317 also includes a log database 325, a license database 327, and a profile database 329. The log database 325 includes a power usage log and an exception log. As discussed above, the server unit 317, through the service process 321, retrieves power usage information from each client computer 205, and stores this retrieved power usage information in the power usage log of the log database 311. Similarly, the server unit 317, through the service process 321, receives the exception information stored in the exception log of each client computer 205. The server unit 317 then stores this exception information in the exception log maintained by the log database 325, for use by, for example, the network administrator. As will be discussed below, the profile database 329 is used to store various power management profiles for distribution to the client computers 205. The license database 327 is then used to store license information for the client computers 205, to ensure that only properly licensed users communicate with the server unit 317. Each of the databases 325-329 may be embodied in any suitable memory medium, such as the RAM memory 109, the hard disk drive 111, the removable disk drive 113, or the optical disk drive 115.

The server unit 317 also includes a task bar notification icon process 331 and a setup process 333. As discussed above with regard to the client unit 303, the implementation and use of a task bar notification icon process is well within the knowledge of those of ordinary skill in the art, and thus will not be discussed herein in detail. The setup process facilitates the configuration of the server unit 317 on the computer 205. Like the task bar notification icon process 331, the implementation and use of the setup process 333 is well within the knowledge of those of ordinary skill in the art. Accordingly, the setup process 333 will not be discussed in detail.

With various embodiments of the invention, the server unit 317 allows an authorized party, such as a network administrator, to segregate each of the client units 303 in the network 201 into different groups. Thus, an authorized manager may use the server unit 317 to classify the client units 303 for computers 205_{A} and 205_{B} into a first group, the client unit 303 for computer 205_{B} into a second group, and the client unit 303 for computer 205_{φ} into a third group. By differentiating the various client computers 205 into groups, an authorized manager can conveniently review power usage information for an entire group of computers 205. Further, the authorized manager can synchronize a power management profile between the computers 205 in a particular group.

For example, the authorized manager may decide that computers 205_{A} and 205_{B} are used to perform critical functions, such as network management functions, while computers 205_{C} and 205_{φ} are used to perform functions of medium and low importance, respectively, such as word processing and data entry. Accordingly, the authorized manager can ensure that the computers 205_{A} and 205_{B} of the first group receive and implement a power management profile suitable for the functions performed by these computers. Thus, the authorized manager may instruct the server unit 317 to synchronize the client units 303 of these computers to enforce a single power management profile that prevents the computers 205_{A} and 205_{B} from entering the hibernate or suspend states. The authorized party can then have the server unit 317 instruct the client unit 303 for the second group with computer 205_{C} to implement a power management profile that allows the computer 205_{C} to enter the hibernate or suspend state after a suitable period of inactivity. Still further, the authorized party can have the third group, with the computer 205_{φ}, implement a power management profile that forces this computer to enter the suspend state after just a short period of inactivity.

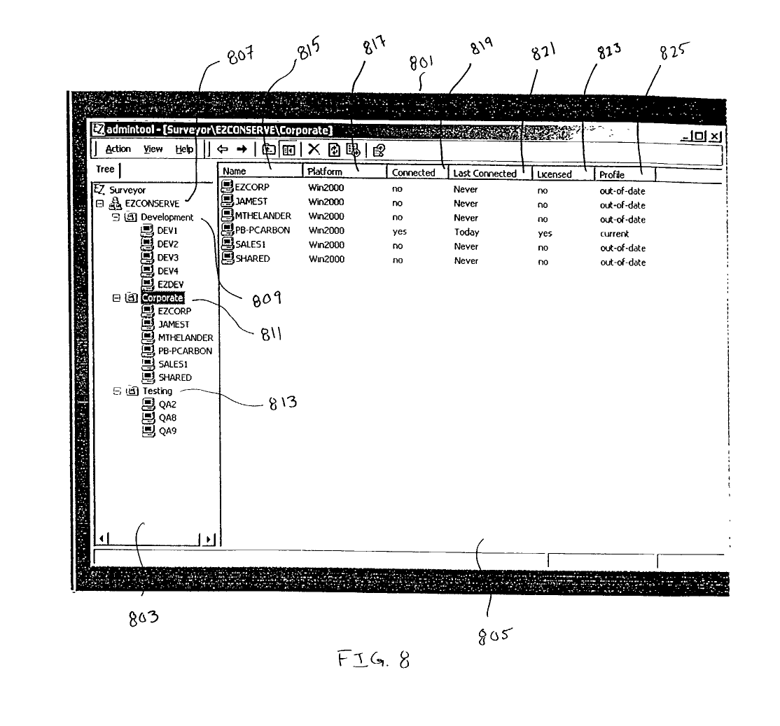

FIG. 8 illustrates an interface 801 that may be provided by the administrative tool 323. This interface 801 conveniently allows an authorized party to classify computers 205 with the client unit 303 into groups. As seen in this figure, the interface 801 includes a conventional “tree” display 803 and a “list” display 805. The tree display 803 displays the various units of the network selected for viewing by the authorized party. For example, in FIG. 8, the tree display 803 shows a network domain 807 entitled “EZCONSERVE,” along with the three groups of computers 809, 811, and 813 making up the domain. Below each group is a listing of the individual computers 205 included in that group. The interface tools used to display different branches of the tree in this type of interface are well known in the art, and thus will not be described here in detail. Of course, while each of the groups shown in FIG. 8 contain more than one computer 205, a group may contain only a single computer 205.

As will be appreciated by those of ordinary skill in the art, the list display 805 lists the items included in the object that the authorized party has selected in the tree display 803. For example, in FIG. 8, the group 811 (entitled “CORPORATE”) is selected in the tree display 803. The list display thus includes each individual computer included in the group 811. In addition to simply identifying the name of these individual computers, the list display 805 may also provide additional information regarding each listed computer. In FIG. 8, the list display 805 includes a “name” column 815 listing the name of each computer 205 in the group, a “platform” column 817 listing the operating system platform of each computer 205 in the group, and a “connected” column 819 indicating whether the client unit 303 for the computer 205 is currently connected to the server unit 317.

The list display 805 also has a “last connected” column 821, indicating when the client unit 303 for each computer 205 in the selected group last connected to the server unit 317. This information may be useful to the authorized party (for example, the network administrator) when determining why a particular computer 205 has not been implementing an assigned power management profile. The list display 805 also includes a “licensed” column 823, indicating whether each computer 205 is licensed to communicate with the server unit 317, and a “profile” column 825, indicating whether the client unit 303 for that client computer 205 has received the power management profile currently assigned to it by the server unit 317.

As discussed above, the server unit 317 allows an authorized party to designate or define a particular power management profile, distribute that power management profile to one or more selected client computers 205 through their associated client units 303, and then enforce adherence to the power management profile by each of the selected client computers 205 through their associated client units 303. With the illustrated embodiment of the invention, the authorized party accomplishes these functions using the interface 801. More particularly, the authorized user can select a particular group of client computers 205 in the interface 801, and activate a “profile” command to define a power management profile for the computers 205 of that group. For example, with some embodiments of the invention, an authorized party may activate the profile command by selecting the desired group and pressing a designated button, such as the right button of a mouse or other pointing unit. This will then provide the authorized party with a drop down command menu including the profile command, which the authorized party may then select. Of course, other techniques for activating the profile command will be apparent to those of ordinary skill in the art.

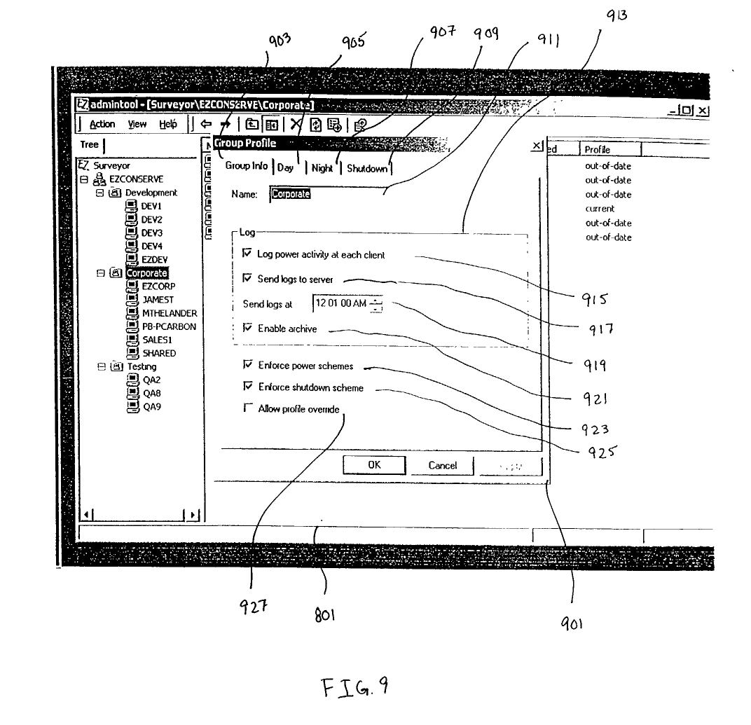

Activating the profile command will provide the authorized party with an interface, such as the interface 901 illustrated in FIG. 9, for defining a power management profile to be assigned to all of the client units 303 of the selected group. As seen in this figure, the interface 901 includes a group information tab 903, a day tab 905, a night tab 907, and a shutdown tab 909. When the group information tab 903 is selected, the interface 901 displays a name field 911 and a log display 913. The name field 911 displays the name of the selected group of client computers 205. With some embodiments of the invention, it may also allow the authorized party to change the name of the group.

The log display 913 contains a number of command fields that enables the authorized party to designate how the client units 303 in the group will record the monitored power usage information and exception information. Thus, when field 915 is selected (by placing a check mark in the field in the shown embodiment), the client unit 303 on each client computer 205 in the group will be required to monitor and record the power activity of that client computer 205 and exceptions to implemental of the power management profile. Similarly, selecting the field 917 will require the client unit 303 on each client computer 205 in the group to transmit the recorded power usage information and exception information to the server unit 317 at the time designated in field 919. Selecting the field 921 will require the client unit 303 on each client computer 205 in the group to archive the power usage information and exception information locally.

Thus, with the illustrated embodiment, the interface 901 for defining a power management profile also allows a user to designate instructions to the client units 303 for recording and monitoring the power usage and exception information. This conveniently allows the recording and monitoring instructions to be distributed to the client units 303 with the power management profile. It will be appreciated, however, that the server unit 317 may distribute instructions for monitoring and recording power usage information or exception information separately from the power management profile. Further, with some embodiments of the invention, the server unit 317 may provide the authorized party with a separate interface for designating the power usage information or exception information monitoring and recording instructions.

When the group information tab 903 is selected, the interface 901 displays enforcement fields 923-927. As with the fields 915-921, selection of the fields 923-927 requires each client unit 303 in the selected group to enforce the power management profile parameters designated in the field. Thus, selecting field 923 will require each client unit 303 to force its associated operating system 301 to comply with the designated power schemes. Likewise, selecting field 925 will require each client unit 303 to force its associated operating system 301 to comply with the designated shutdown schemes. Selecting the field 927 will then allow the user for each computer 205 in the selected group to override the designated power management profiles.

As will be appreciated from the foregoing description, a single power management profile containing both a scheduled power scheme and a scheduled shutdown scheme may be distributed to a variety of computers 205 in a group. In some instances, these computers 205 may have different types of operating systems 301, some of which may support the scheduled power scheme but not the scheduled shutdown scheme, and others of which may support the scheduled shutdown scheme but not the scheduled power scheme. With these situations, the authorized party may want the scheduled power scheme enforced instead of the scheduled shutdown scheme when the scheduled power scheme is supported, but want the scheduled shutdown scheme enforced when the scheduled power scheme is not supported. Alternately, the authorized party may want the scheduled shutdown scheme enforced instead of the scheduled power scheme when the scheduled shutdown scheme is supported, but want the scheduled power scheme enforced when the scheduled shutdown scheme is not supported.

To address this potential discrepancy between the operating systems 301 of different computers 205 in a group, the server unit 317 may assign enforcement preferences when the authorized user selects enforcement of both a scheduled power scheme and a scheduled shutdown scheme. For example, the server unit 317 may be configured to create power management profiles that include a preference to enforce scheduled power schemes before (or instead of) enforcing scheduled shutdown schemes. Alternately, the server unit 317 may be configured to create power management profiles that include a preference to enforce scheduled shutdown schemes before (or instead of) enforcing scheduled power schemes.

In order to define a daytime power scheme, the authorized user activates the day tab 905.

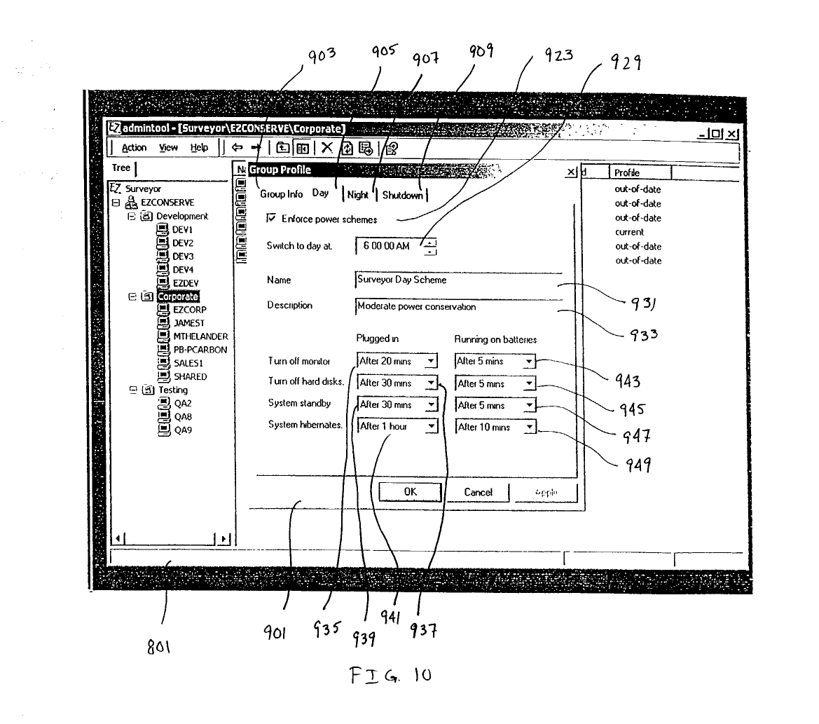

As shown in FIG. 10, activating the day tab 905 causes the interface 901 to display the enforcement field 923, a day selection field 929, a power scheme name field 931, and a description field 933. As previously noted, selecting field 923 will require each client unit 303 to force its associated operating system 301 to comply with the designated power schemes. The day selection field 929 contains the time (e.g., 6:00 AM) when the client units 303 are to begin enforcement of the daytime power scheme. The name field 931 then contains the desired name of the daytime power scheme, while the description field 933 contains a brief description of the daytime power scheme.

Activating the day tab 905 also causes the interface 901 to display fields 935-949. The fields 935, 937, 939 and 941 display the power settings, encompassed by the daytime power scheme identified in field 931, for turning off a monitor associated with each computer 205, turning off the hard disk drives 111 for each computer 205, putting the basic hardware for each computer 205 into a standby mode, and putting each computer 205 into the hibernate mode, respectively, when the computer 205 is plugged into a power source. Similarly, the fields 943, 945, 947 and 949 display the power settings, encompassed by the daytime power scheme identified in field 931, for turning off a monitor associated with each computer 205, turning off the hard disk drives 111 for each computer 205, putting the basic hardware for each computer 205 into a standby mode, and putting each computer 205 into the hibernate mode, respectively, when the computer 205 is operating from battery power. Thus, by selecting the contents of fields 935-949, the authorized party can configure a daytime power scheme to be synchronized among all of the client computers 203 in the selected group.

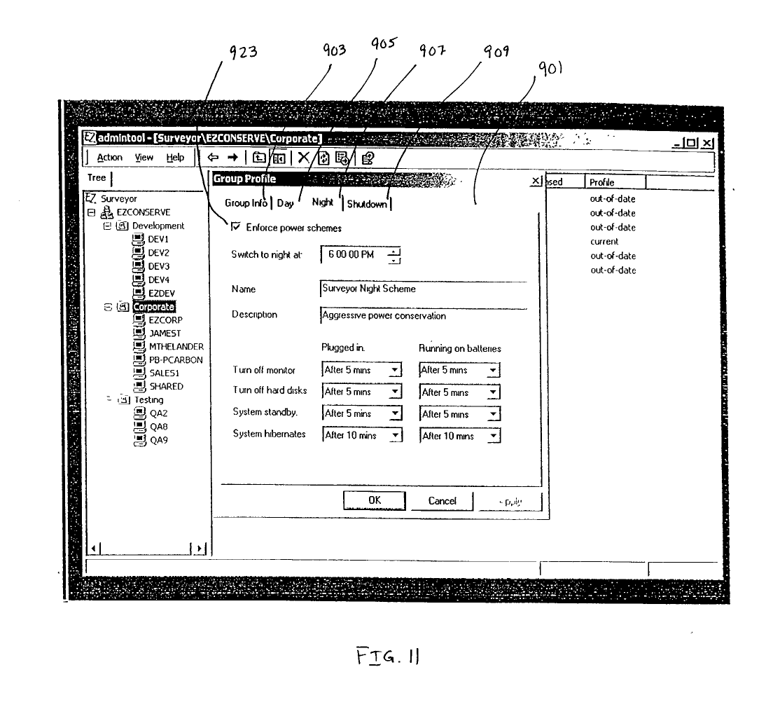

As shown in FIG. 11, activating the night tab 907 causes the display 901 to display fields for defining and scheduling a power scheme like those displayed when the day tab 905 is activated. Thus, this figure will not be described in detail. As will be appreciated by those of ordinary skill in the art, however, the fields corresponding to the night tab allow the authorized party to create, schedule and enforce a nighttime power scheme for each of the computers 205 in the selected group.

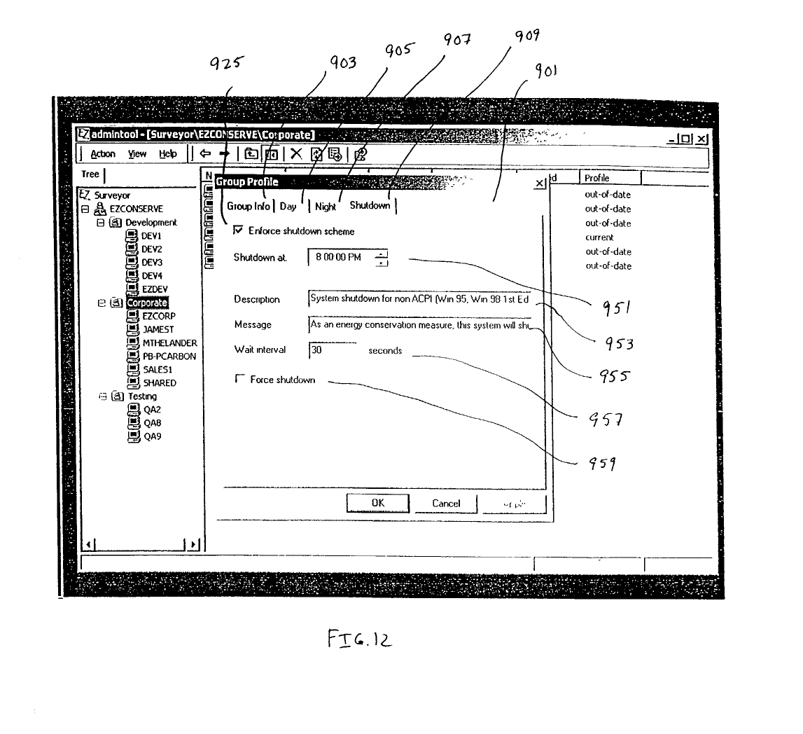

When the shutdown tab 909 is activated, as shown in FIG. 12, the display 901 includes the enforcement field 925, which allows the authorized user to instruct the client units 303 to enforce the shutdown scheme among the client computers 205 of the selected group. The display 901 also includes the shutdown time field 951, the description field 953, the message field 955, the interval field 957, and the enforcement field 959. The shutdown time field 951 contains the time at which the client units 303 must enforce shutdown of the their associated client computers 205. As will be appreciated by those of ordinary skill in the art, the authorized party may vary the time in the time field 951 to change the time at which the client computers 205 will shut down. The description field 953 then contains a description of the shutdown profile.

The message field 955 contains a message that each client unit 303 is to display before enforcing a shutdown of its associated client computer 205. The message field may have, for example, a warning message informing a user that his or her computer will shut down in 30 seconds. The field 957 then contains the time interval after which the message in message field 955 is displayed that the client unit 303 will enforce a shutdown of its associated client computer 205. The enforcement field 959 allows the authorized party to force the client units 303 to comply with the scheduled shutdown scheme defined in the preceding fields 951-957. Thus, an authorized user can specify a particular shutdown scheme, schedule enforcement of that shutdown scheme, synchronize the scheduled shutdown scheme among all of the client computers 205 of a selected group, and enforce adherence to that scheme.

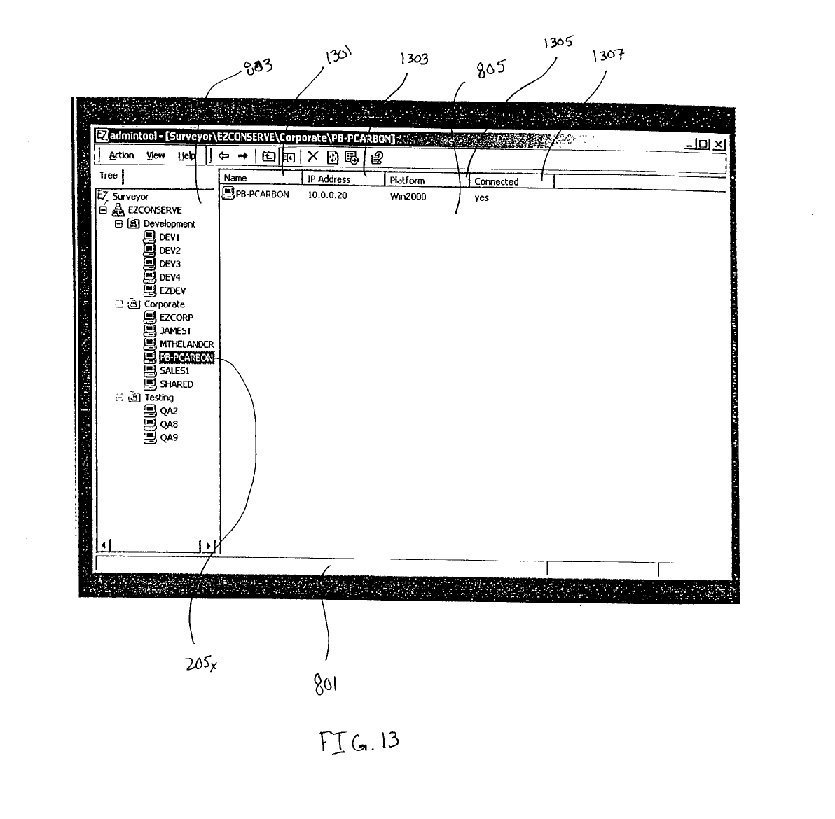

Returning back to the interface 801, those of ordinary skill in the art will appreciate that, in addition to selecting whole groups of client computers 205, various embodiments of the invention may allow an authorized party to also use this interface 801 to select and assign a power management profile to an individual client computer 205. For example, FIG. 13 illustrates a selection of a single client computer 205_{X} (entitled PB-PCARBON) in interface 801. As seen in this figure, when the client computer 205_{X} is selected in the tree display 803, various parameters for that computer 205_{X} are displayed in the list display 803. For example, the list display 803 contains a name column 1301 listing the name of the computer 205_{X}, and an IP address column 1303 listing the current Internet protocol address for the client computer 205_{X}. The list display 803 also includes a platform column 1305 listing the operating system platform employed by the client computer 205_{X}, and a connected column 1307 indicating whether the client computer 205_{X} is currently connected to the server unit 317.

Of course, those of ordinary skill in the art will appreciate that, with some embodiments of the invention, more than one client computer 205 or group of client computers 205 may be selected for listing in the list display 805. Likewise, those of ordinary skill in the art will appreciate how the interface 801 may be used to arrange various individual client computers 205 into an existing group, or collected to form a new group. For example, using a conventional “drag-and-drop” technique, the interface 801 may allow an authorized party to move a client computer 205 from one group to another group.

It should be noted that, in some situations, an authorized party may want a client computer 205 to employ a power management profile with power settings that are not supported by that computer's operating system 301. Thus, some embodiments of the invention may allow an authorized party to create and distribute power settings to the client computers 205. With some embodiments of the invention, the new power settings may be distributed to the client computers 205 with the power management profiles employing those new power settings. Still other embodiments of the invention may permit an authorized party to distribute new power settings to client computers 205 independent of a power management profile.

Those of ordinary skill in the art will also appreciate that the server unit 317 can distribute power management profiles, power usage information and exception information monitoring and recording instructions, and new power settings and power states to the client units 303 or client computers 205 using any known suitable distribution mechanism. For example, the server unit 317 may “push” power management profiles to the client computers 205 when the client computers 205 are connected to the server unit 317. Alternately, the client unit 303 may “pull” power management profiles from the server unit 317 by periodically requesting updates when the client unit 303 is connected to the server unit 317. Similarly, with some embodiments of the invention, the client units 303 may “push” recorded power usage information or exception information to the server unit 317, while, with other embodiments of the invention, the server unit 317 may “pull” recorded power usage information or exception information from the client units 303.

Returning now to the server service process 321, it retrieves the power usage information collected by each participating client unit 303 as previously noted, and stores that retrieved power usage information in the power consumption log maintained in the log database 325. With some embodiments of the invention, an authorized party may use the administrative tool 323 to retrieve this power usage information from the log database 325 for viewing and analysis. Alternately, or additionally, the authorized party may use a separate report viewer to retrieve the power usage information from the log database 325 for viewing and analysis. For example, an authorized party may use a spreadsheet application, such as Microsoft Excel, to retrieve and display selected power usage information. With these embodiments, the server unit 317 may additionally include an exporter process to convert the stored format of the power usage information into a format more suitable for the report viewer.

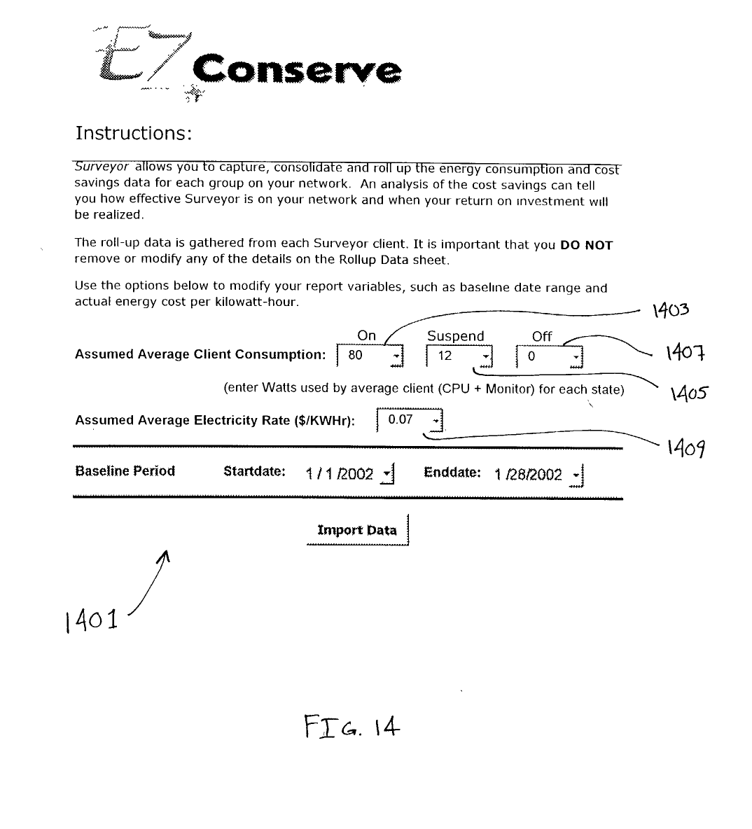

FIG. 14 illustrates one such user interface 1401, provided by a Microsoft Excel spreadsheet application, for viewing power consumption data for the client computers 205. With this embodiment, each client unit 303 has monitored and recorded when its associated client computer 205 entered into the on power state, the suspend power state, and the shutdown or off power state. The interface 1401 includes fields 1403, 1405 and 1407 containing the amount of power consumed per hour by the average client computer 205 during the on state, the suspend state, and the off state, respectively. The interface 1401 also includes a field 1409 containing the estimated cost of power per hour. An authorized user can thus enter the appropriate values into the fields 1403-1409, and retrieve the power usage data from the participating client units 303 to determine the cost of the power consumption by those client units 303.

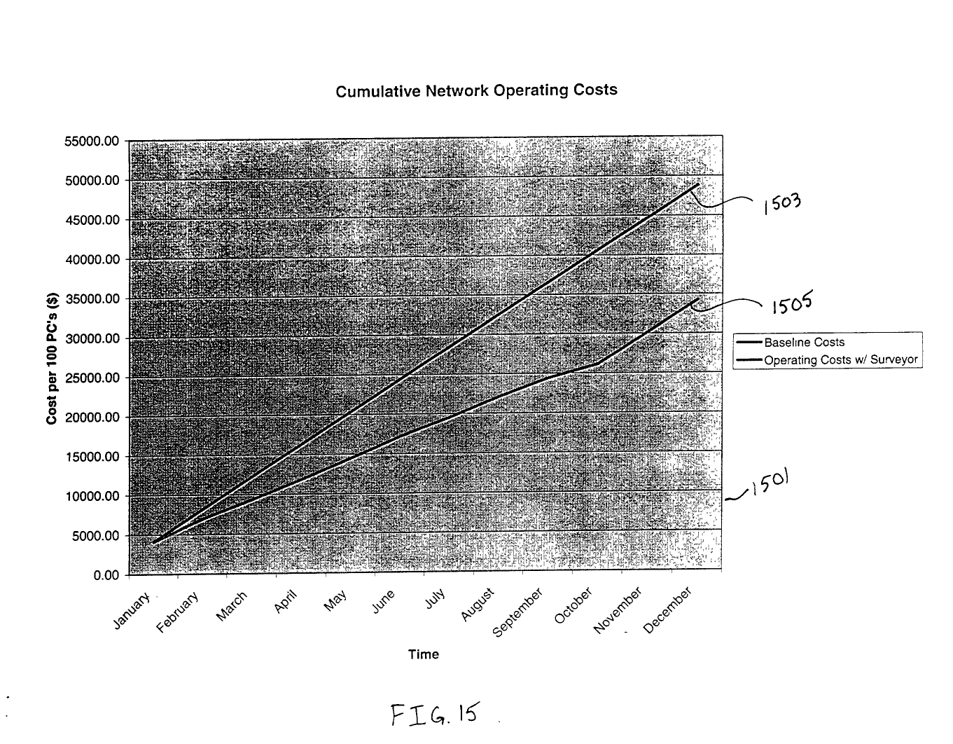

Of course, those of ordinary skill in the art will appreciate that the power usage information collected by the client units 303 can be employed in a variety of ways, depending upon the desired use of the information. For example, FIG. 15 shows a graph 1501 displaying the cumulative cost of power consumption versus time. The graph 1501 contains two lines 1503 and 1505. Line 1503 represents the amount of power that would have been used by the client computers 205 in an exemplary network 201 without the client units 303. With the particular graph shown in FIG. 15, this information is obtained by monitoring the power consumption of the computers 205 for the month of January, without enforcing a power management profile. The values thus obtained for the month of January are then extrapolated for the remainder of the year. Line 1505 then represents the amount of power actually consumed by the client computers 205 using the power management profiles distributed and enforced through the server unit 317 from February through the remainder of the year. It should be noted, however, other graphs may be created to display a wide variety of data using the retrieved power usage information.

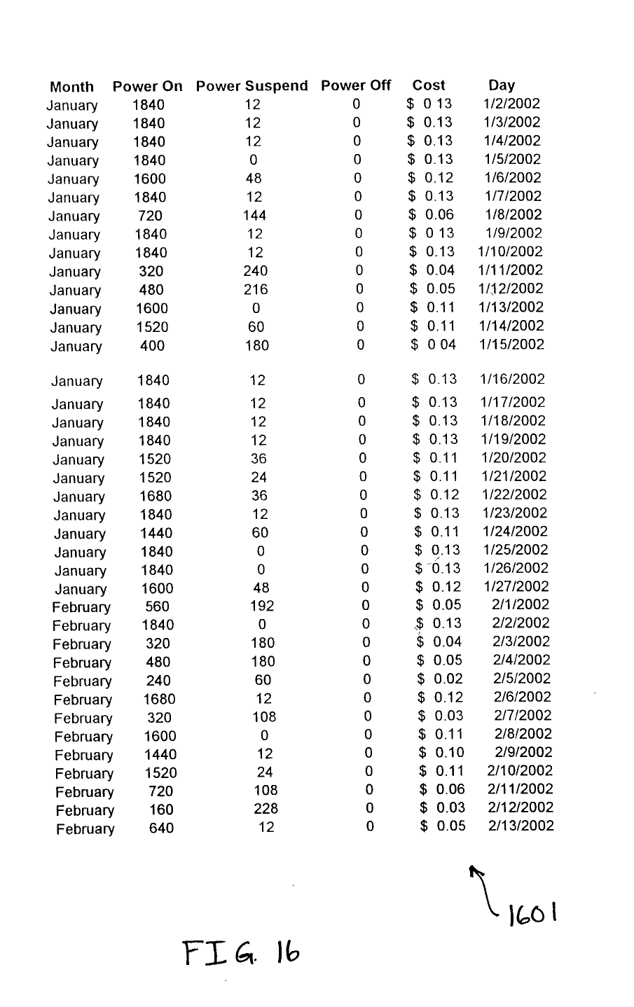

Another possible use of the power usage information is illustrated in FIG. 16. This figure shows a table 1601 listing the average power usage for an exemplary network for each consecutive day through Jan. 1, 2002, to Feb. 13, 2002. For each day, the table 1601 identifies the month, the power consumed by the computers 205 in the on state, the power consumed by the computers 205 in the suspend state, and the power consumed by the computers 205 in the off state. The table 1601 also shows the cost of the consumed power, and the day corresponding to the cost. Of course those of ordinary skill in the art will appreciate that still other tables, graphs, charts and other data analysis tools can be generated using the retrieved power usage information, in order to assist an authorized user to analyze power consumption by the computers 205.

With the above-described embodiments, the server unit 317 may be implemented on a server computer 203 using software, hardware, firmware, or any combination thereof. It should be noted, however, that with other embodiments of the invention the server unit 317 might be a discrete device separate from a server computer. For example, the server unit 317 could be a standalone device employing software, hardware, firmware, or any combination thereof. With these embodiments, the server unit 317 may communicate with each computer 205, so as to provide power management profiles and monitoring and recording instructions, and to control implementation of the power management profiles.

Also, it should be noted that, while only a single server computer 203 was shown in FIG. 2, a network 201 may employ multiple server computers 203 and/or multiple server units 317.

Operation Of The Invention

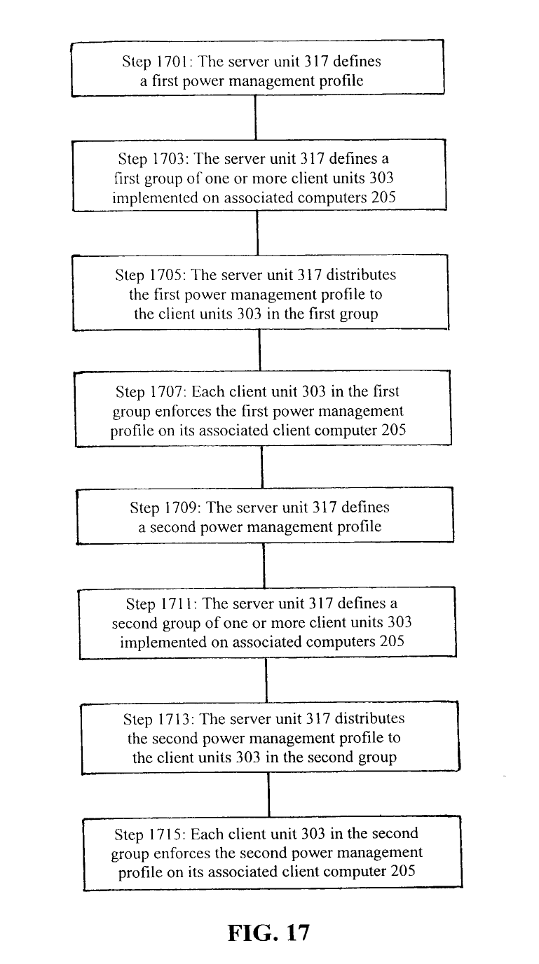

The operation of one embodiment of the invention in defining, distributing and enforcing a power management profile is shown in FIG. 17. As seen in this figure, in step 1701, an authorized party, such as a network administrator, employs the administrative tool 323 of the server unit 317 to define a first power management profile. Next, in step 1703, the authorized party uses the administrative tool 323 of the server unit 317 to define a first group of one or more client units 303 implemented on associated client computers 205. In step 1705, the server unit 317 distributes the first power management profile to the client units 303 in the first group. Upon receiving or retrieving the distributed power management profile, each client unit 303 in the first group enforces the power management profile on its associated client computer 205 in step 1707.

Next, in step 1709, the authorized party employs the administrative tool 323 of the server unit 317 to define a second power management profile. Then, in step 1711, the authorized party uses the administrative tool 323 of the server unit 317 to define a second group of one or more client units 303 implemented on associated client computers 205. In step 1713, the server unit 317 distributes the second power management profile to the client units 303 in the second group. As with the first group of client units 303, in step 1715 each client unit 303 in the second group enforces the second power management profile on its associated client computer 205 upon receiving or retrieving the second power management profile.

It should be noted that, in the above-described method, steps 1709-1715 are optional, and may be omitted entirely if desired. Further, the described order of steps may be varied as desired. For example, the authorized party may define a group of client units 303 on associated client computers 205 before defining a power management profile for that group. Also, either the second group of client units 303 or the second power management profile may be defined before either the first group of client units 303 or the first power management profile. Moreover, a single power management profile could be distributed to both the first group of client units 303 and the second group of client units 303. The method also could be expanded to define as many groups of client units 303 and as many power management profiles as desired. Still other variations of the method will be apparent to those of ordinary skill in the art.

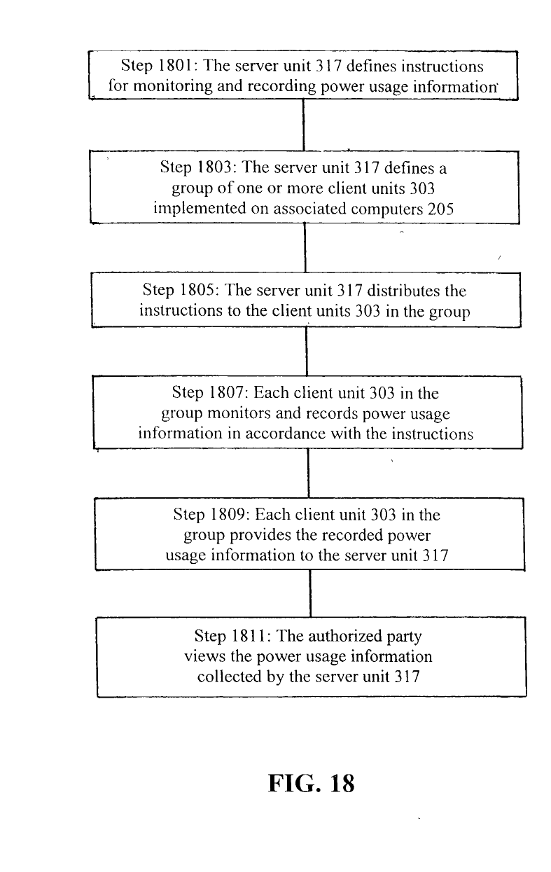

FIG. 18 illustrates the operation of one embodiment of the invention in defining, distributing and implementing instructions to monitor and record power usage information. As seen in this figure, in step 1801, an authorized party, such as a network administrator, employs the administrative tool 323 of the server unit 317 to define instructions for monitoring and recording power usage information. Next, in step 1803, the authorized party uses the administrative tool 323 of the server unit 317 to define a group of one or more client units 303 implemented on associated client computers 205. In step 1805, the server unit 317 distributes the instructions for monitoring and recording power usage information to the client units 303 in the group. Upon receiving or retrieving the instructions, in step 1807 each client unit 303 in the group monitors and records power usage information in accordance with the instructions. Next, in step 1809, each client unit 303 in the group provides the recorded power usage information to the server unit 317. Then, in step 1811, the authorized party views the power usage information collected by the server unit 317.

It should be noted that, in the above-described method, the order of steps may be varied as desired. For example, the authorized party may define a group of client units 303 on associated client computers 205 before defining the power usage information monitoring and recording instructions for the group. Also, the method could be expanded to define as multiple groups of client units 303 and multiple sets of instructions for monitoring and recording power usage information. Of course, still other variations of the method will be apparent to those of ordinary skill in the art.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method of controlling the power usage of a computer, comprising:
defining a schedule for implementing at least one power setting on a computer; and
enforcing the at least one power setting on the computer according to the schedule.

2. The method of controlling the power usage of a computer recited in claim 1, wherein the schedule includes a reoccurring time period.

3. The method of controlling the power usage of a computer recited in claim 1, wherein the schedule includes a specific calendar date.

4. The method of controlling the power usage of a computer recited in claim 1, wherein the schedule includes a time period occurring on a specific calendar date.

5. The method of controlling the power usage of a computer recited in claim 1, further including defining and enforcing the schedule for a plurality of power settings on the computer.

6. The method of controlling the power usage of a computer recited in claim 1, further including:
defining a second schedule for implementing at least one power setting on the computer, the second schedule being different from the first schedule; and
enforcing the at least one power setting on the computer according to the second schedule.

7. The method of controlling the power usage of a computer recited in claim 6, wherein the at least one power setting enforced according to the first schedule is different from the at least one power setting enforced according to the second schedule.

8. A method of controlling the power usage of a computer, comprising:
defining a schedule for implementing at least one reduced-power state on a computer; and
enforcing the at least one reduced-power state on the computer according to the schedule.

9. The method of controlling the power usage of a computer recited in claim 8, wherein the reduced power state is selected from the group consisting of: suspend, standby and hibernate.

10. The method of controlling the power usage of a computer recited in claim 8, further including:
defining a second schedule for implementing at least one reduced-power state on the computer; and
enforcing the at least one reduced-power state according to the second schedule.

11. The method of controlling the power usage of a computer recited in claim 10, wherein the reduced power state enforced according to the first schedule is different from the reduced power state enforced according to the second schedule.

12. A method of controlling the power usage of a computer, comprising:
receiving a power management profile at a computer from a source other than the computer, the power management profile including at least one power setting and a schedule for implementing the at least one power setting on the computer; and
enforcing the at least one power setting on the computer according to the schedule.

13. The method of controlling the power usage of a computer recited in claim 12, wherein the source is a second computer networked with the first computer.

14. The method of controlling the power usage of a computer recited in claim 12, wherein the source is a power control unit communicates with the computer.

15. The method of controlling the power usage of a computer recited in claim 12, wherein the schedule includes a reoccurring time period.

16. The method of controlling the power usage of a computer recited in claim 12, wherein the schedule includes a specific calendar date.

17. The method of controlling the power usage of a computer recited in claim 12, wherein the schedule includes a time period occurring on a specific calendar date.

18. The method of controlling the power usage of a computer recited in claim 12, wherein the power management profile includes a plurality of power settings to be implemented on the computer according to the schedule.

19. The method of controlling the power usage of a computer recited in claim 12,
wherein the power management profile includes a second schedule for implementing at least one power setting on the computer, the second schedule being different from the first schedule; and
further including enforcing the at least one power setting on the computer according to the second schedule.

20. The method of controlling the power usage of a computer recited in claim 19, wherein the at least one power setting enforced according to the first schedule is different from the at least one power setting enforced according to the second schedule.

21. A method of controlling the power usage of a computer, comprising:
receiving a power management profile at a computer from a source other than the computer, the power management profile including a reduced-power state and a schedule for implementing the reduced-power state; and
enforcing the reduced-power state according to the schedule.

22. The method of controlling the power usage of a computer recited in claim 21, wherein the source is a second computer networked with the first computer.

23. The method of controlling the power usage of a computer recited in claim 21, wherein the source is a power control unit communicating with the computer.

24. The method of controlling the power usage of a computer recited in claim 21, wherein the reduced power state is selected from the group consisting of: suspend, standby and hibernate.

25. The method of controlling the power usage of a computer recited in claim 21,
wherein the power management profile includes a second schedule for implementing a reduced-power state; and
further including enforcing the reduced-power state according to the second schedule.

26. The method of controlling the power usage of a computer recited in claim 25, wherein the reduced power state enforced according to the first schedule is different from the reduced power state enforced according to the second schedule.

27. A method of controlling the power usage of a computer, comprising:
defining a power management profile for a computer, the power management profile including at least one power setting and a schedule for implementing the at least one power setting on the computer; and
distributing the power management profile to the computer.

28. The method of controlling the power usage of a computer recited in claim 27, further including distributing the power management profile to the computer through a network of computers.

29. The method of controlling the power usage of a computer recited in claim 27, further including distributing the power management profile to the computer through a power control unit communicating with the computer.

30. The method of controlling the power usage of a computer recited in claim 27, wherein the schedule includes a reoccurring time period.

31. The method of controlling the power usage of a computer recited in claim 27, wherein the schedule includes a specific calendar date.

32. The method of controlling the power usage of a computer recited in claim 27, wherein the schedule includes a time period occurring on a specific calendar date.

33. The method of controlling the power usage of a computer recited in claim 27, wherein the power management profile includes a plurality of power settings to be implemented on the computer according to the schedule.

34. The method of controlling the power usage of a computer recited in claim 27, wherein the power management profile includes a second schedule for implementing at least one power setting on the computer, the second schedule being different from the first schedule.

35. The method of controlling the power usage of a computer recited in claim 34, wherein the at least one power setting to be implemented according to the first schedule is different from the at least one power setting to be implemented according to the second schedule.

36. The method of controlling the power usage of a computer recited in claim 27, further including:
defining a group of one or more computers; and
distributing the power management profile to each of the computers in the group.

37. The method of controlling the power usage of a computer recited in claim 36, further including:
defining a second group of one or more computers different from the first group of one or more computers;
defining a second power management profile, the power management profile including at least one power setting and a schedule for implementing the at least one power setting; and
distributing the second power management profile to each of the computers in the second group.

38. The method of controlling the power usage of a computer recited in claim 36, further including:
defining a second group of one or more computers different from the first group of computers;
defining a second power management profile, the power management profile including a reduced power state and a schedule for implementing the reduced power state; and
distributing the second power management profile to each of the computers in the second group.

39. A method of controlling the power usage of a computer, comprising:
defining a power management profile for a computer, the power management profile including a reduced power state and a schedule for implementing the reduced power state on the computer; and
distributing the power management profile to the computer.

40. The method of controlling the power usage of a computer recited in claim 39, further including distributing the power management profile to the computer through a network of computers.

41. The method of controlling the power usage of a computer recited in claim 39, further including distributing the power management profile to the computer through a power control unit communicating with the computer.

42. The method of controlling the power usage of a computer recited in claim 39, wherein the reduced power state is selected from the group consisting of: suspend, standby and hibernate.

43. The method of controlling the power usage of a computer recited in claim 39, wherein the power management profile includes a second schedule for implementing a reduced power state.

44. The method of controlling the power usage of a computer recited in claim 43, wherein the reduced power state to be implemented according to the first schedule is different from the reduced power state to be implemented according to the second schedule.

45. The method of controlling the power usage of a computer recited in claim 39, further including:
defining a group of one or more computers; and
distributing the power management profile to each of the computers in the group.

46. The method of controlling the power usage of a computer recited in claim 39, further including:
defining a second group of one or more computers different from the one or more computers of the first group;
defining a second power management profile, the power management profile including a reduced power state and a schedule for implementing the reduced power state; and
distributing the second power management profile to each of the computers in the second group.

47. A method of determining power usage of a computer, comprising:
instructing a computer to monitor power usage information relating to power usage by the computer; and
instructing the computer to record the monitored power usage information.

48. The method of determining power usage of a computer recited in claim 47, wherein the power usage information includes each power state maintained by the computer and a time period during which the computer maintains each power state.

49. The method of determining power usage of a computer recited in claim 47, wherein the power usage information includes each power state maintained by the computer and a time duration for which the computer maintains each power state.

50. The method of determining power usage of a computer recited in claim 47, wherein the power usage information includes the actual amount of power consumed by the computer.

51. A method of determining power usage of a computer, comprising:
receiving at a computer from a source other than the computer instructions to monitor power usage information relating to power usage by the computer; and
providing the monitored power usage information to the source.

52. The method of determining power usage of a computer recited in claim 51, further including receiving at a computer from a source other than the computer instructions to record the monitored power usage information.

53. The method of controlling the power usage of a computer recited in claim 51, wherein the source is a second computer networked with the first computer.

54. The method of controlling the power usage of a computer recited in claim 51, wherein the source is a power control unit communicating with the computer.

55. The method of determining power usage of a computer recited in claim 51, wherein the power usage information includes each power state maintained by the computer and a time period during which the computer maintains each power state.

56. The method of determining power usage of a computer recited in claim 51, wherein the power usage information includes each power state maintained by the computer and a time duration for which the computer maintains each power state.

57. The method of determining power usage of a computer recited in claim 51, wherein the power usage information includes the actual amount of power consumed by the computer.

58. The method of determining power usage of a computer recited in claim 51, wherein the instructions further define when to provide the monitored power usage information to the source.

59. A method of determining power usage of a computer, comprising:
distributing to a computer instructions for the computer to monitor and transmit power usage information relating to power usage by the computer; and
receiving the monitored power usage information from the computer.

60. The method of determining power usage of a computer recited in claim 59, further including distributing to the computer instructions for the computer to record the monitored power usage information.

61. The method of controlling the power usage of a computer recited in claim 59, further including distributing the instructions to the computer through a network.

62. The method of controlling the power usage of a computer recited in claim 59, further including distributing the instructions to the computer through a power control unit communicating with the computer.

63. The method of determining power usage of a computer recited in claim 59, wherein the power usage information includes each power state maintained by the computer and a time period during which the computer maintains each power state.

64. The method of determining power usage of a computer recited in claim 59, wherein the power usage information includes each power state maintained by the computer and a time duration for which the computer maintains each power state.

65. The method of determining power usage of a computer recited in claim 59, wherein the power usage information includes the actual amount of power consumed by the computer.

66. The method of determining power usage of a computer recited in claim 59, wherein the instructions further define when the monitored power usage information should be transmitted.

67. The method of controlling the power usage of a computer recited in claim 59, further including:
defining a group of one or more computers; and
distributing the instructions to each of the computers in the group.

68. The method of controlling the power usage of a computer recited in claim 59, further including:
defining a second group of one or more computers different from the first group of one or more computers;
defining second instructions for a computer to monitor and transmit power usage information relating to power usage by the computer; and
distributing the second instructions to each of the computers in the second group.

69. The method of controlling the power usage of a computer recited in claim 68, wherein the first instructions are different from the second instructions.

70. The method of determining power usage of a computer recited in claim 69, wherein the second instructions further define when the monitored power usage information should be transmitted.
